(19) United States
(12) Patent Application Publication
(10) Pub. No.: US 2022/0324766 A1
(43) Pub. Date: Oct. 13, 2022

(54) ORGANOMINERAL FERTILIZER AND PROCESS THEREFOR

(71) Applicant: Paulee Cleantec Ltd., Tel Aviv (IL)

(72) Inventors: Ilan Levy, Kfar Harif (IL); Oded Halperin, Bazra (IL)

(73) Assignee: Paulee Cleantec Ltd., Tel Aviv (IL)

(21) Appl. No.: 17/640,892

(22) PCT Filed: Sep. 14, 2020
(86) PCT No.: PCT/IB2020/058505

§ 371 Date: Mar. 7, 2022

Related U.S. Application Data
(60) Provisional application No. 62/900,544, filed on Sep. 15, 2019.

(51) Int. Cl. C05F 9/02; C05F 3/06; C05F 5/00

(52) U.S. Cl. CPC C05F 9/02; C05F 3/06; C05F 5/00

(57) ABSTRACT

A method for producing an organomineral fertilizer from organic waste includes mixing organic waste with an oxidizing agent to cause an oxidizing reaction that causes combustion of the organic waste to form an oxidated waste matter, supplementing the oxidated waste matter with a chemical or mineral fertilizer to form tut organomineral mixture, drying the organomineral mixture to reduce a water content thereof and obtain a drier organomineral mixture, and forming the drier organomineral mixture into a desired shape, such as powder, granules or pellets, etc.

### FIELD OF THE INVENTION

The present invention relates to organomineral fertilizers and methods for making such substances from organic waste, such as but not limited to, sewage sludge or animal exudates or any other forms of organic waste and organic matter.

### BACKGROUND OF THE INVENTION

Fertilizers, like mineral fertilizers and organic fertilizers are known in the art and are widely used in agriculture. Every year, millions of tons of organic waste are disposed of in a non-sustainable way by incineration and landfilling. The separate use of organic or inorganic fertilizers in recent years has not really met the expected impact in boosting crop yield to cope with the geometric food demand. In view of this, the combined use of chemical (mineral) fertilizers and organic fertilizers to formulate one product has been suggested and coined as organomineral fertilizer. Organomineral fertilizer thus has the potential of improving the poor nutritional status of soils in a sustainable approach thus facilitating and promoting the economical practice to enhance crop production. It combines the good attributes of both sources to enhance yield. In many parts of the world, the emphasis has shifted from the separate use of organic or inorganic fertilizers to combined use. For example, PCT Patent Application WO02/06186 describes a method for the preparation of organomineral fertilizer granules in which dried manure is mixed with urea and minerals and fed to a granulator. A disadvantage of this organomineral fertilizer is that the release of nitrogen (urea) and minerals is very fast. This means that a repeated fertilization with this organomineral fertilizer is necessary.

US Patent Application 20130283870 to Abramov describes processing of organic waste materials (livestock and poultry farming waste, domestic and industrial waste water, straw, peat and other organic substances) to produce organomineral fertilizers in granulated form. The method includes feeding mixture components, removing mechanical impurities, mixing with the addition of mineral components, grinding, decontaminating, homogenizing, granulating and drying. The grinding, decontamination, homogenization and granulation processes are performed simultaneously on continuously operating heated rollers with the mass to be processed being passed through shaping rings of the rollers and with cutting to form granules. The granules are dried to a set moisture content in a continuously operating heated vacuum dryer operating in pulsed vacuum modes. The device for producing a granulated organomineral fertilizer from organic waste materials consists of means for feeding the mixture components, removing mechanical impurities, mixing, grinding, decontaminating, homogenizing, granulating and drying.

All of the prior art methods suffer from the long period of time and high amount of energy needed for processing, composting or decomposing animal wastes and sludge.

### SUMMARY OF THE INVENTION

The present invention seeks to provide a novel process for producing organomineral fertilizers from organic waste, such as but not limited to, sewage sludge or animal exudates, as described in detail below. The present invention eliminates the step of anaerobic or aerobic decomposition of animal wastes, sewer sludge and the like, and instead uses a chemical composting process, thereby realizing significant savings in energy, cost and time.

There is thus provided in accordance with an embodiment of the present invention a method producing organomineral fertilizers from organic waste includes mixing organic waste with oxidizing agents to cause an oxidizing (and exothermic) reaction that causes combustion of the organic waste to form an oxidated organic waste matter, mixing the oxidated organic waste matter with mineral fertilizer to form an organomineral mixture, drying the mixture to reduce a water content thereof and obtain a drier organomineral mixture, and forming the drier organomineral mixture into a desired shape, such as powder, granules or pellets, etc., as required for a proper soil application.

### BRIEF DESCRIPTION OF THE DRAWINGS

The present invention will be understood and appreciated more fully from the following detailed description, taken in conjunction with the drawing in which:

FIG. 1 is a flow chart of a method for producing organomineral fertilizers from organic waste, in accordance with a non-limiting embodiment of the present invention.

### DETAILED DESCRIPTION OF EMBODIMENTS

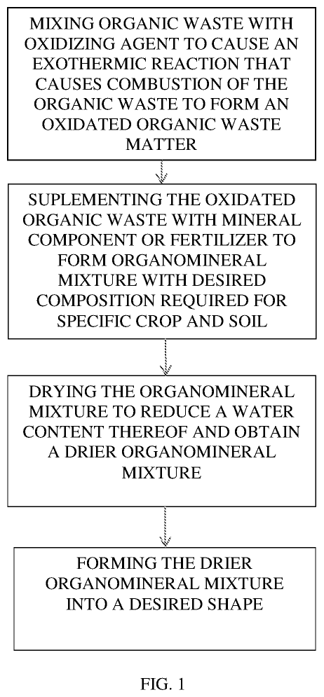

Reference is now made to FIG. 1, which illustrates a method for producing organomineral fertilizers from organic waste, in accordance with a non-limiting embodiment of the present invention.

In step 1, organic waste (animal waste, sludge, sewer waste, etc.) is mixed with an oxidizing agent, in accordance with methods described in U.S. Pat. Nos. 9,039,053 and 9,936,842, the disclosures of which are incorporated herein by reference.

In one example, apparatus for carrying out the invention may include a receptacle for holding therein organic waste, and optionally a blender (mixer) for mixing and/or grinding (chopping, pulverizing, etc.) the organic waste for more efficient oxidation thereof. A collection receptacle may be provided for collecting therein products of oxidation of the organic waste. A dispenser dispenses an oxidizing agent to the organic waste so as to cause an oxidizing (and exothermic) reaction that causes combustion of the organic waste. Non-limiting examples of the oxidizing agent include a peroxide, such as hydrogen peroxide, calcium peroxide, and/or magnesium peroxide, etc.; a persulphate, such as sodium persulphate, potassium persulphate, and/or ammonium persulphate, etc.; ozone; a permanganate, such as sodium permanganate, potassium permanganate, etc.; chlorine dioxide; and/or a halogen, such as chlorine, bromine, iodine, and/or fluorine, etc. The oxidizing agents can be used each alone or in admixture of two or more, and may be liquid, solid, gel and the like.

Accordingly, step 1 is an accelerated chemical composting process that reduces or eliminates pathogens and odors. The oxidated waste matter may be used as an organomineral fertilizer, but may in general still be too wet, that is, it may have a higher than desired water content for forming desired finished shapes, such as pellets.

In step 2, the oxidated organic waste matter is supplemented with a chemical/mineral fertilizer to form an organomineral mixture to achieve a desired nutrient composition that will best suit soil and crop requirements.

In step 3, the wet mixture is then transferred into a dryer machine to reduce its water content and obtain an adequate level of water content. It is noted that steps 1, 2 and 3 can be separated into different machines or may be carried out in a single step in one machine.

In step 4, the dried organomineral mixture is physically formed to obtain the desired shape of powder, granules or pellets, etc.

A major advantage in the inventive process over the prior art is that it is extremely fast (5-40 minute process) compared with the prior art methods of forming organomineral fertilizers that typically take weeks.

The method of the invention is applicable for any wet organic waste stream, such as but not limited to, domestic, municipal, agricultural, industrial and farm animal waste.

Waste streams from different sources may be combined in one process delivering one final product type or different types.

The ratio between organic and minerals in the product can vary from 5% organic and 95% mineral to 95% mineral to 5% organic material. The mineral fraction may comprise any combination of macro-elements required by plants, such as nitrogen, phosphorus, potassium and others; and micro-elements required by plants such as Mg, Mn, Co, B, Fe, S, Mo, Zn, and others.

It is not necessary to have all the above components, and the composition can vary according to the final product specification.

Potting soil is generally used with potted plants in indoor settings. Because potted plants lack natural nutrients found in topsoil and due to the plant growth environment, potting soil is required to be different from topsoil in terms of composition. Unlike topsoil, potting soil may have little or no natural soil content because it is manufactured from natural and man-made ingredients. Often it is made of different ingredients such as moss, sphagnum, bark, coconut husks, vermiculite, and coir. These ingredients are used in the soil in order to allow enough air to the roots, while keeping a soil-like texture that promotes moisture retention and adequate drainage as needed in potted plants. Potting soil is sterilized, which helps in eliminating any growth of harmful substances to the plant such as weeds and fungus. For potted plants, this is critical for they are in a moist environment and hence quite vulnerable to harmful substances.

An additional use for the invention is for potting soil or soil amendment. The product made according to the invention has the following basic elements required:

a. It has excellent draining and water will not stand idle in it.

b. It can maintain at least a little bit of moisture.

c. It is strong enough to support the plant.

d. It has nutritional value for plants

These basic product properties make it an excellent component in potting soil mixtures and for soil remediation and amendment. It can replace traditional components such as moss, sphagnum, bark, coconut husks, vermiculite, coir and others.

What is claimed is:

1. A method for producing an organomineral fertilizer from organic waste comprising:
mixing organic waste with an oxidizing agent to cause an oxidizing reaction that causes combustion of the organic waste to form an oxidated waste matter;
supplementing said oxidated waste matter with a chemical or mineral fertilizer to form an organomineral mixture;
drying said organomineral mixture to reduce a water content thereof and obtain a drier organomineral mixture; and
forming said drier organomineral mixture into a desired shape.

2. The method according to claim 1, wherein said mixing organic waste with said oxidizing agent to cause the oxidizing reaction is an accelerated chemical composting process that reduces or eliminates pathogens and odors.

3. The method according to claim 1, wherein said mixing, said supplementing, said drying and said forming are all completed in 5-40 minutes.

4. The method according to claim 1, wherein said organic waste comprises a wet organic waste stream.

5. The method according to claim 1, wherein said organic waste comprises domestic, municipal, agricultural, industrial or farm animal waste.

6. The method according to claim 1, comprising using said desired shape as a potting soil to grow indoor potted plants.
